(19) United States
(12) Patent Application Publication
(10) Pub. No.: US 2020/0354241 A1
(43) Pub. Date: Nov. 12, 2020

(54) LIQUID TREATMENT APPARATUS AND LIQUID TREATMENT METHOD

(71) Applicant: SUGINO MACHINE LIMITED, Jozu City (JP)

(72) Inventor: Akihiro TANII, Uozu City (JP)

(73) Assignee: SUGINO MACHINE LIMITED

(21) Appl. No.: 16/779,445

(22) Filed: Jan. 31, 2020

(30) Foreign Application Priority Data
May 10, 2019 (JP) 2019-089954
Nov. 29, 2019 (JP) 2019-215987

(51) Int. Cl. C02F 1/52; C02F 1/46; B01D 17/04

(52) U.S. Cl. CPC C02F 1/52; B01F 3/04; B01D 17/045; C02F 1/4608

(57) ABSTRACT

Provided are a liquid treatment apparatus and a liquid treatment method for reducing a waste amount of a high specific gravity liquid.

The liquid treatment apparatus includes: a liquid supply pump to supply a treatment liquid stored in a tank; a bubble tank into which the treatment liquid flows, and including a floating matter discharge port arranged near a liquid surface of the treatment liquid, and to discharge a floating matter floated on the treatment liquid; a microbubble generator arranged outside the bubble tank, and to generate microbubbles by mixing air into the treatment liquid supplied from the liquid supply pump; a separation tank connected the bubble tank at a lower portion of the bubble tank; and a circulation pipe configured to return the treatment liquid overflown from the liquid surface in the separation tank to the tank.

### CROSS-REFERENCE TO RELATED APPLICATIONS

This application claims the benefit of priority to Japanese Patent Application No. 2019-089954, filed on May 10, 2019, and Japanese Patent Application No. 2019-215987, filed on Nov. 29, 2019, the entire contents of which are hereby incorporated by reference.

### BACKGROUND

### 1. Technical Field

The present invention relates to a liquid treatment apparatus and a liquid treatment method.

### 2. Description of the Background

An emulsion demulsifying apparatus having a tank, a microbubble generator arranged in the tank, a liquid supply device for supplying a liquid to the microbubble generator, and a gas supply device for supplying a gas such as air to the microbubble generator has been proposed (Japanese Unexamined Patent Application Publication No. 2015-155092). In the conventional emulsion demulsifying apparatus, an emulsion in a liquid is demulsified by microbubbles emitted from the microbubble generator, separated into at least two kinds of liquids having no affinity to each other, and one liquid is floated together with the microbubbles.

### BRIEF SUMMARY

In the conventional emulsion demulsifying apparatus, the high specific gravity liquid is discarded together with the low specific gravity liquid to be removed.

The present invention provides a liquid treatment apparatus and a liquid treatment method for reducing a waste amount of a high specific gravity liquid.

A first aspect of the present invention provides a liquid treatment apparatus, including:

a liquid supply pump configured to supply a treatment liquid stored in a tank;

a bubble tank into which the treatment liquid flows, the bubble tank including a floating matter discharge port arranged near a liquid surface of the treatment liquid, the floating matter discharge port configured to discharge a floating matter floated on the treatment liquid;

a microbubble generator arranged outside the bubble tank, the microbubble generator configured to generate microbubbles by mixing air into the treatment liquid supplied from the liquid supply pump;

a separation tank connected the bubble tank at a lower portion of the bubble tank; and

a circulation pipe configured to return the treatment liquid overflown from the liquid surface in the separation tank to the tank.

A second aspect of the present invention provides a liquid treatment method, including:

mixing microbubbles, at outside of a bubble tank, into a treatment liquid containing foreign matter or oil content, the treatment liquid stored in a tank;

supplying the treatment liquid mixed with the microbubbles into the bubble tank;

floating the microbubbles in the bubble tank by adhering the microbubbles to the foreign matter or the oil content;

flowing the treatment liquid into a separation tank through a lower part of the bubble tank;

circulating the treatment liquid from the separation tank into the tank; and

discharging a floating matter from above a liquid surface of the bubble tank.

Preferably, the bubble tank is a closed tank. The microbubble generator is arranged outside the bubble tank. The microbubble generator is arranged in a path connecting the tank and the bubble tank. The lower end of the bubble outlet is apart from the liquid surface of the treatment liquid. Preferably, the upper end of the bubble outlet is lower than the top plate. The space extending above the liquid surface of the bubble tank is called as a bubble floating tank. The discharge port is arranged in the bubble tank. The height of the discharge port is in the vicinity of the liquid level. The height of the discharge port may be higher than the liquid level. The defoaming pump is a vacuum pump. The coalescer is disposed below the liquid surface of the treatment liquid.

For example, the bubble generator is a air-shear type. The bubble generator may be a rotational flow type bubble generator.

According to the liquid treatment apparatus and the liquid treatment method of the present invention, the waste amount of the high specific gravity liquid can be reduced.

### BRIEF DESCRIPTION OF DRAWINGS

FIG. 1 shows a liquid treatment apparatus according to the first embodiment.

FIG. 2 is a perspective view of a partially removed treatment tank according to the first embodiment.

FIG. 3 is a cross-sectional view taken along plane III of FIG. 2.

FIG. 4 is a flowchart showing a liquid treatment method according to the first embodiment.

FIG. 5 shows a liquid treatment apparatus according to the second embodiment.

FIG. 6 is a perspective view of a partially removed treatment tank according to the second embodiment.

### DETAILED DESCRIPTION

### First Embodiment

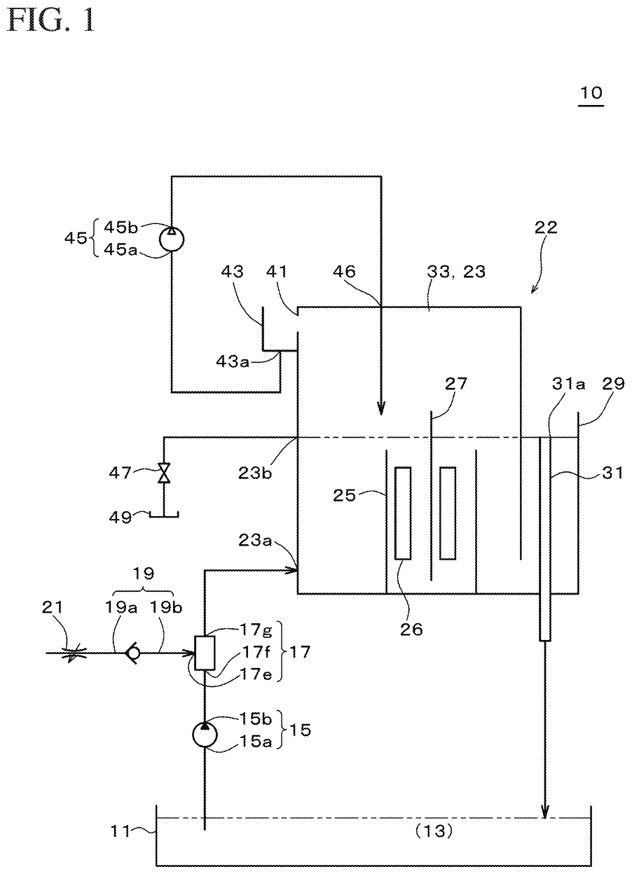

As shown in FIG. 1, a liquid treatment apparatus 10 according to the present embodiment includes a liquid supply pump 15, a generator (a microbubble generator) 17, and a treatment tank 22. The liquid treatment apparatus 10 may include a check valve 19, a throttle 21, a discharge valve (a floating matter discharge valve) 47, a defoaming pump 45, and a drain tank 49.

The liquid treatment apparatus 10 removes foreign matter and oil content contained in a treatment liquid 13 stored in the tank 11. The tank 11 is, for example, a tank of a machine tool or a washing machine. The treatment liquid 13 is, for example, an aqueous coolant or an aqueous cleaning liquid. The foreign matter is, for example, chip, fiber scrap, or abrasive grains. The oil content is, for example, oil or grease. The foreign matter and the oil content are turbid in the treatment liquid 13.

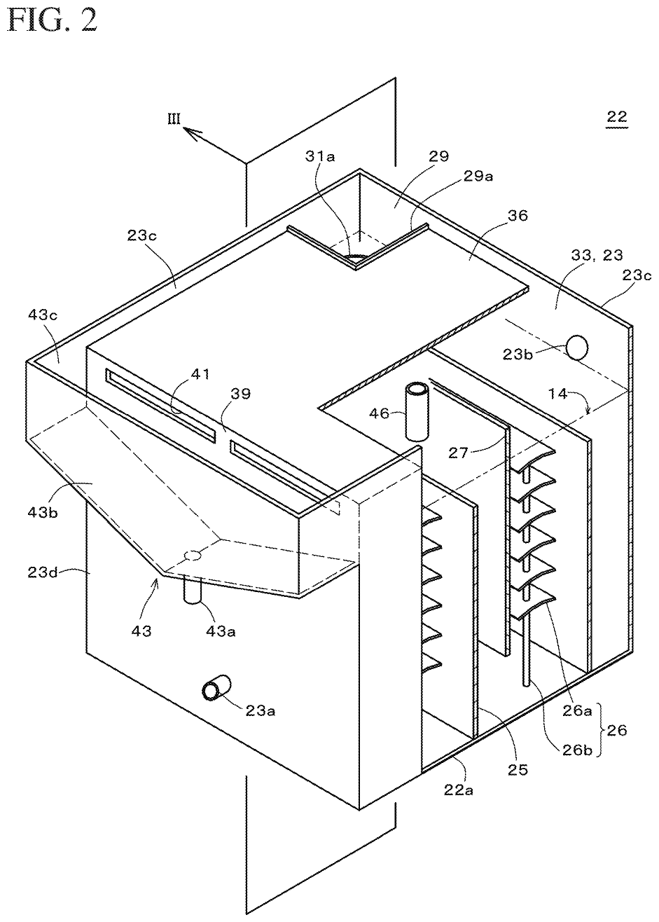

As shown in FIG. 2, the treatment tank 22 includes a bubble tank 23, a separation tank 29, a circulation port 31a, and a discharge port (a floating matter discharge port) 23b. The treatment tank 22 may include a top plate 36, a side wall 39, a lower partition plate 25, an upper partition plate 27, a circulation pipe 31, an external thread 31b, an inlet port (a second inlet port) 23a, a bubble outlet 41, a collecting trough 43, a return port 46, and a coalescer 26.

The treatment tank 22 is substantially rectangular parallelepiped and has a bottom surface 22a. For example, the treatment tank 22 is installed above the tank 11. The bottom surface 22a is shared by the bubble tank 23 and the separation tank 29. The bottom surface 22a may be arranged horizontally.

The separation tank 29 is disposed atone corner of the treatment tank 22 when viewed from above. The separation tank 29 is separated from the bubble tank 23 by an L-shaped separation wall 29a when viewed from above. A lower portion of the separation wall 29a is opened to connect the separation tank 29 and the bubble tank 23.

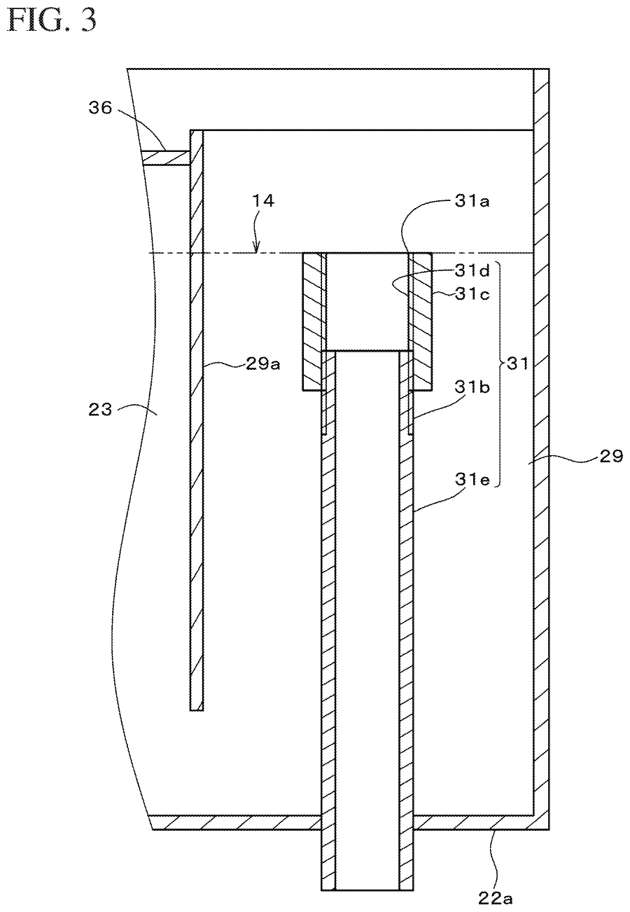

Plane III includes the centerline of the circulation pipe 31. As shown in FIG. 3, the circulation pipe 31 is disposed upright in the center of the separation tank 29. An opening at the upper end of the circulation pipe 31 serves as a circulation port 31a. The treatment liquid 13 flowing into the treatment tank 22 overflows to the circulation port 31a and returns to the tank 11. The height of the liquid surface 14 of the treatment liquid 13 is determined by a position of the circulation port 31a.

The circulation pipe 31 may include a fixed pipe 31e, an external thread 31b, and an adjustment port 31c. The fixed pipe 3e is disposed upright from the bottom surface 22a. The external thread 31b is formed at the upper end portion of the fixed pipe 31e. The adjustment port 31c has an internal thread 31d on its inner surface. The adjustment port 31c is screwed into the external thread 31b. The circulation pipe 31 is connected to the tank 11. The liquid level adjustment port 31c adjusts the height of the liquid surface 14 in the separation tank 29 by the screwing amount.

As shown in FIG. 2, the bubble tank 23 includes side plates 23c. 23d, a top plate 36, and a side wall 39. The upper end of the side plate 23c may be higher than the top plate 36. The upper end of the side plate 23c may be higher than the upper end of the separation wall 29a. The upper end of the side wall 39 is lower than the upper end of the side plate 23c. The side wall 39 separates the bubble tank 23 from the collecting trough 43. The top plate 36 may be arranged horizontally. The height of the top plate 36 is surely higher than the liquid surface 14. The bubble tank 23 is closed by the side plate 23c, the side wall 39, and the top plate 36. The bubble tank 23 includes a floating chamber 33, which is a closed space, above the liquid surface 14.

The bubble outlet 41 is arranged on the upper part of the side wall 39. The lower end of the bubble outlet 41 is located surely above the liquid surface 14. Preferably, the upper end of the bubble outlet 41 is separated from the top plate 36. One or more bubble outlets 41 may be arranged. The bubble outlet 41 may be disposed on one side far from the separation tank 29 when viewed from above.

The upper partition plate 27 stands inside the bubble tank 23 with a gap from the bottom surface 22a. The upper partition plate 27 is parallel to the side plate 23d. The upper end of the upper partition plate 27 is higher than the circulation port 31a. The upper partition plate 27 extends above the liquid surface 14.

The lower partition plate 25 is in contact with the bottom surface 22a, and stands on the bubble tank 23. The lower partition plate 25 is disposed between the side plate 23d and the upper partition plate 27 in parallel with the side plate 23d. The upper end of the lower partition plate 25 is lower than the circulation port 31a. The upper end of the lower partition plate 25 is located below the liquid surface 14.

One or more upper partition plates 27 and one or more lower partition plates 25 may be disposed. For example, only one lower partition plate 25 may be disposed. The upper partition plate 27 and the lower partition plate 25 are alternately arranged.

The collecting trough 43 is connected to the upper part of the side plate 23d, and is disposed outside the bubble tank 23. The collecting trough 43 is arranged to face the bubble outlet 41. The collecting trough 43 includes a side plate 43c, a bottom plate 43b, and a collecting port 43a. The side plate 43c is continuous with the side plate 23c. The upper end of the side plate 43c may have the same height as the upper end of the side plate 23c. Preferably, the bottom plate 43b is inclined downward toward the collecting port 43a. The collecting port 43a is disposed at the bottom of the collecting trough 43.

The discharge port 23b is disposed at substantially the same height as the circulation port 31a. The discharge port 23b may be disposed slightly higher than the circulation port 31a. The discharge valve 47 is a two-way valve. The discharge valve 47 is, for example, a manual valve or a solenoid valve. The discharge port 23b is connected to one port of the discharge valve 47. The other port of the discharge valve 47 is connected to a drain tank 49.

The inlet port 23a is disposed at the lower part of the side plate 23d. The inlet port 23a may be disposed on the bottom surface 22a. Preferably, the inlet port 23a is disposed at a position far from the separation tank 29 when viewed from above. For example, the inlet port 23a is disposed at a position farther from the separation tank 29 than the lower partition plate 25 and the upper partition plate 27.

The return port 46 may be disposed on the top plate 36. The return port 46 extends in the vertical direction. The lower end of the return port 46 may be disposed below the circulation port 31a. Preferably, when viewed from above, the return port 46 is located at a position far from the separation tank 29. For example, the return port 46 is disposed at a position farther from the separation tank 29 than the lower partition plate 25 and the upper partition plate 27 when viewed from above.

The coalescer 26 is disposed along the side plate 23d, the upper partition plate 27, and the lower partition plate 25. The coalescer 26 has a plurality of plates 26a and connecting rods 26b. The plate 26a is, for example, in an elongated rectangle shape, and extends horizontally. The plate 26a has a size of, for example, 30 mm×60 mm to 50 mm×100 mm. The two long sides of the plate 26a are bent downward, for example. The cross section of the plate 26a may be V-shaped or U-shaped. The plates 26a are arranged in the vertical direction at equal intervals, for example. The plurality of plates 26a are connected by the connecting rod 26b.

The liquid supply pump 15 has a liquid supply port 15a and a discharge port 15b. The liquid supply pump 15 is, for example, a centrifugal pump or a pneumatically driven diaphragm pump. The liquid supply pump 15 may be disposed in the tank 11. The discharge port 15b is connected to the inlet port 23a via the generator 17. The liquid supply port 15a is connected to the tank 11.

The generator 17 is, for example, a known microbubble generator. The generator 17 is, for example, of the air shear type. Preferably, the generator 17 generates bubbles having a size between 20 μm and 50 μm.

The generator 17 is arranged outside the bubble tank 23. The generator 17 has an air inlet 17e, a treatment liquid inlet 17f, and an outlet (a second outlet port) 17g. Preferably, the air inlet 17e is connected to the outside air via a check valve 19 and a throttle 21. The check valve 19 has an inlet (a first inlet port) 19a and an outlet (a first outlet port) 19b. The inlet 19a is connected to a throttle 21. The outlet 19b is connected to the air inlet 17e. The check valve 19 prevents the treatment liquid from being discharged from the air inlet 17e to the outside air. The treatment liquid inlet 17f is connected to the discharge port 15b. The outlet 17g is connected to the inlet port 23a.

The defoaming pump 45 has a suction port 45a and a discharge port 45b. The defoaming pump 45 is, for example, an ejector pump, a diaphragm pump, or a rotary pump. The suction port 45a is connected to the collecting port 43a. The discharge port 45b is connected to the return port 46.

The bubble outlet 41, the collecting trough 43, the defoaming pump 45, and the return port 46 may be omitted.

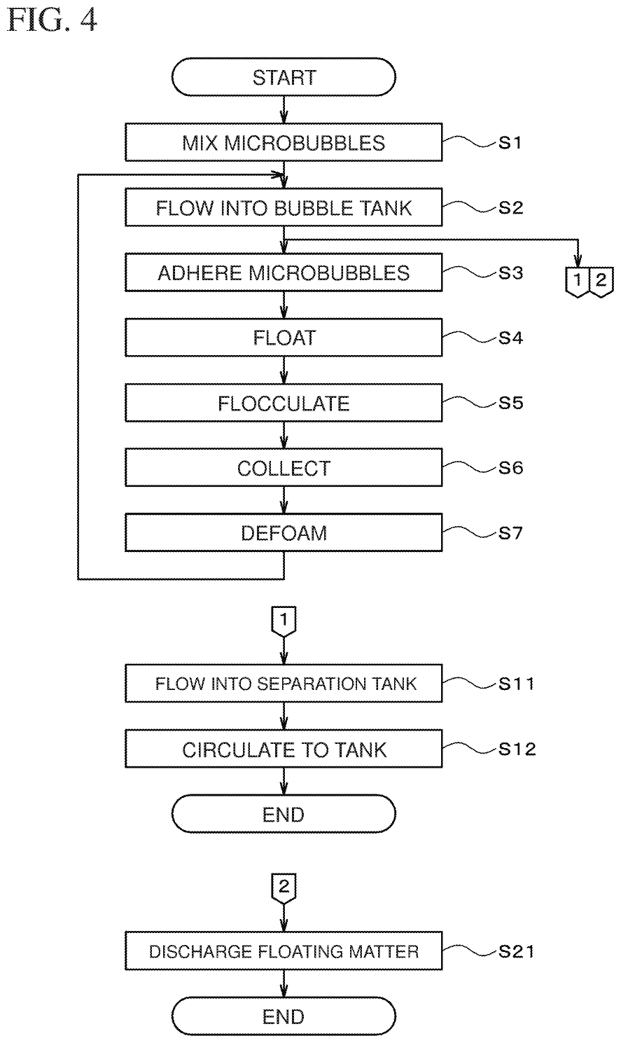

The liquid treatment method will be described with reference to FIGS. 1 and 4.

The liquid supply pump 15 supplies the treatment liquid 13 from the tank 11 to the generator 17. In step S1, the generator 17 sucks air from the air inlet 17e, and mixes the air into the treatment liquid 13 as fine bubbles.

In step S2, the treatment liquid 13 mixed with the fine bubbles flows into the bubble tank 23 from the inlet port 23a.

In step S3, the fine bubbles adhere to the oil content or foreign matter in the treatment liquid 13.

The treatment liquid 13 flows through the bubble tank 23 while circulating above the lower partition plate 25 and below the upper partition plate 27. In step S4, the oil content or foreign matter to which the fine bubbles are adhered floats in the bubble tank 23.

In step S5, the oil content and foreign matter to which the bubbles are adhered are flocculated. When the treatment liquid 13 flows through the coalescer 26, the flow of the treatment liquid 13 is disturbed. The oil content or foreign matter to which the air bubbles are adhered collides with the plate 26a, or the oil content or foreign matter to which the air bubbles are adhered comes into contact with each other, thereby promoting the flocculation of the oil content or foreign matter.

The oil content and foreign matter float as a floating matter in the floating chamber 33 together with the bubbles. When the floating matter fills the floating chamber 33, the floating matter overflows from the bubble outlet 41. In step S6, the overflowing floating matter is collected in the collecting trough 43.

The defoaming pump 45 sucks the collected floating matter. In step S7, the bubbles in the floating matter collapse and disappear upon depressurization. The defoamed floating matter flows into the bubble tank 23 through the return port 46.

In step S11, the treatment liquid 13 flows into the separation tank 29 from below the separation wall 29a.

In step S12, the treatment liquid 13 overflows into the circulation port 31a and circulates to the tank 11 through the circulation pipe 31.

In step S21, the discharge valve 47 is opened to discharge the floating matter from the discharge port 23b. The discharge valve 47 is opened, for example, every 500 hours to discharge the floating matter.

Steps S1 to S7. S11, and S12 are executed continuously. Steps S6 and S7 may be omitted.

The floating matter overflown from the bubble outlet 41 is collected in the collecting trough 43, and returned to the bubble tank 23 after defoamed. Therefore, the treatment liquid 13 contained in the floating matter discharged from the discharge port 23b decreases.

Since the bubble tank 23 is closed, the disappearance of bubbles is enhanced. Since the side plate 23c extends upwardly beyond the top plate 36, the bubbles overflown from the bubble outlet 41 are restrained from overflowing from the treatment tank 22.

### Second Embodiment

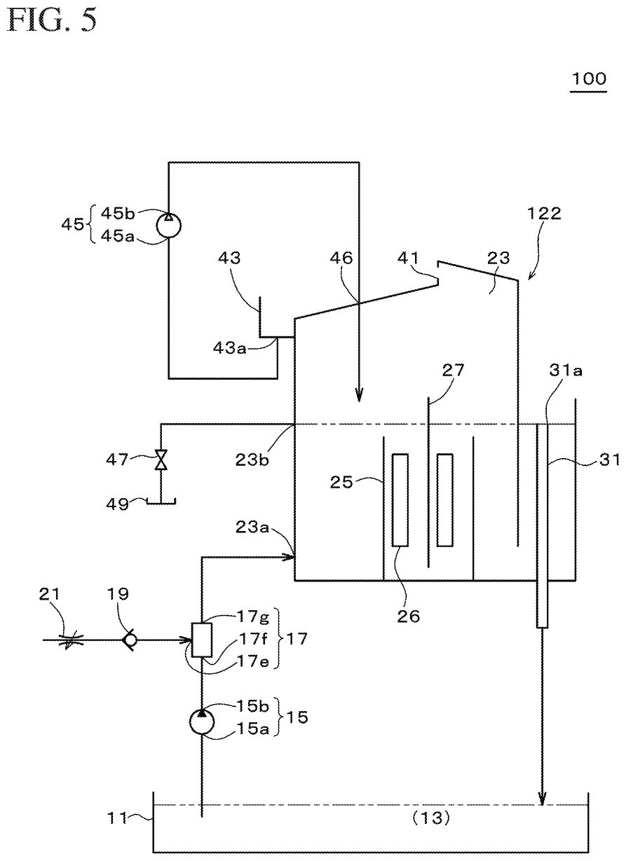

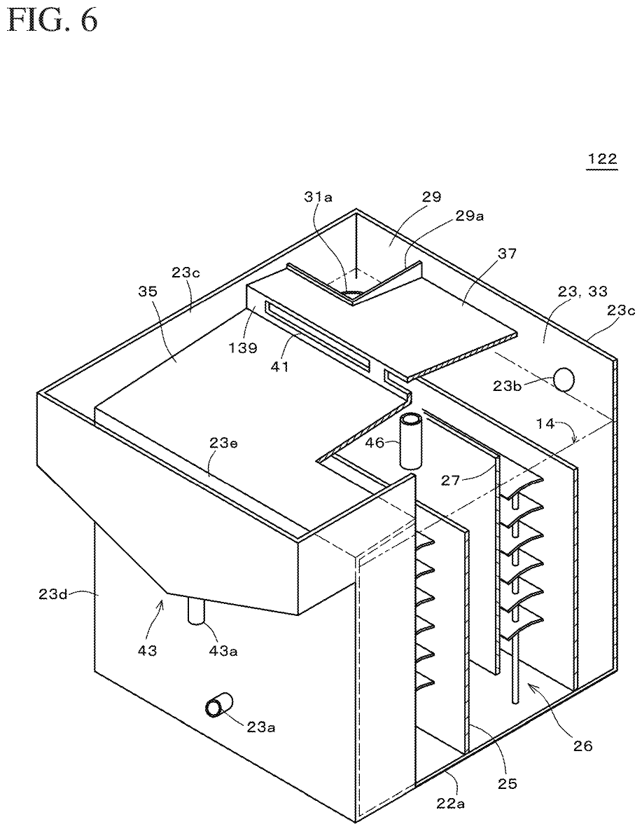

As shown in FIGS. 5 and 6, the liquid treatment apparatus 100 of the present embodiment includes a treatment tank 122. The treatment tank 122 includes a first top plate 35, a second top plate 37, a side plate 23e, and a side wall 139.

The side plate 23e partitions the bubble tank 23 and the collecting trough 43. The upper end of the side plate 23e is lower than the upper end of the side plate 23c.

The first top plate 35 and the second top plate 37 cover the upper portion of the bubble tank 23.

The first top plate 35 is inclined so as to get higher from the upper end of the side plate 23e toward the center of the treatment tank 122. The first top plate 35 is connected to the side plate 23e.

The second top plate 37 is disposed higher than the first top plate 35 at the center of the treatment tank 122. The second top plate 37 may be inclined such that a point distant from the side plate 23d is downward. The second top plate 37 is connected to the separation wall 29a. The second top plate 37 is surely separated from the liquid surface 14.

The bubble outlet 41 is disposed above the first top plate 35 and below the second top plate 37. The bubble outlet 41 is located above the circulation port 31a. A side wall 139 may be disposed between the first top plate 35 and the second top plate 37. The bubble outlet 41 may be disposed in the side wall 139. For example, the side wall 139 having a narrow width in the vertical direction is disposed between the first top plate 35 and the second top plate 37, and a plurality of elongated bubble outlets 41 extending horizontally are disposed on the side wall 139. The side wall 139 holds the first top plate 35 and the second top plate 37.

The return port 46 may be disposed on the first top plate 35.

The liquid treatment method will be described with reference to FIG. 4. Floating oil content and foreign matter float above the liquid surface 14 together with bubbles. When the floating matter fills the floating chamber 33, the floating matter overflows from the bubble outlet 41. The overflown floating matter flows down the upper surface of the first top plate 35, and is collected in the collecting trough 43 in step S6.

The other steps are the same as those of the first embodiment.

It should be noted that the present invention is not limited to the embodiments described above, and various modifications can be made without departing from the gist of the present invention, and all technical matters included in the technical idea described in the claims are the subject matter of the present invention. While the foregoing embodiments illustrate preferred examples, those skilled in the art will appreciate that various alternatives, modifications, variations, or improvements may be made in light of the teachings disclosed herein and are within the scope of the appended claims.

### REFERENCE SIGNS LIST

10 Liquid treatment apparatus
11 Tank
13 Treatment liquid
17 Generator (microbubble generator)
23 Bubble tank
23b Discharge port (floating matter discharge port)
29 Separation tank
43 Collecting trough
45 Defoaming pump
31a Circulation port

What is claimed is:

1. A liquid treatment apparatus, comprising:
a liquid supply pump configured to supply a treatment liquid stored in a tank;
a bubble tank into which the treatment liquid flows, the bubble tank including a floating matter discharge port arranged near a liquid surface of the treatment liquid, the floating matter discharge port configured to discharge a floating matter floated on the treatment liquid;
a microbubble generator arranged outside the bubble tank, the microbubble generator configured to generate microbubbles by mixing air into the treatment liquid supplied from the liquid supply pump;
a separation tank connected to the bubble tank at a lower portion of the bubble tank; and
a circulation pipe configured to return the treatment liquid overflown from the liquid surface in the separation tank to the tank.

2. The liquid treatment apparatus according to claim 1, further comprising:
a check valve including
a first inlet port connected to an outside air, and
a first outlet port,
wherein the bubble tank includes a second inlet port arranged in a lower portion of the bubble tank,
the microbubble generator includes
a treatment liquid inlet connected to the liquid supply pump,
an air inlet connected to the first outlet, and
a second outlet port connected to the second inlet port.

3. The liquid treatment apparatus according to claim 1, further comprising:
a floating matter discharge valve connected to the floating matter discharge port.

4. The liquid treatment apparatus according to claim 1, further comprising:
a lower partition plate arranged in the bubble tank, the lower partition plate having
a lower end connected to a bottom surface of the bubble tank, and
an upper end located below the liquid surface, and
an upper partition plate arranged in the bubble tank, the upper partition plate having
an upper end located above the liquid surface, and
a lower end located above the bottom surface near the bottom surface.

5. The liquid treatment apparatus according to claim 1, further comprising:
a coalescer arranged in the bubble tank, the coalescer including a plurality of plates each extending in a horizontal direction, the plurality of plates separately arranged in a vertical direction.

6. The liquid treatment apparatus according to claim 1, wherein
the bubble tank includes a bubble outlet arranged at upper portion of the bubble tank,
the liquid treatment apparatus further comprising:
a collecting trough arranged below the bubble outlet, the collecting trough configured to collect the floating matter discharged from the bubble outlet; and
a defoaming pump including
a suction port connected to the collecting trough, and
a discharge port connected to the bubble tank.

7. The liquid treatment apparatus according to claim 6, wherein
the bubble tank includes a side wall, and
the bubble outlet is arranged on the side wall.

8. The liquid treatment apparatus according to claim 6, wherein
the bubble outlet is arranged in an upper portion of the bubble tank apart from the liquid surface.

9. The liquid treatment apparatus according to claim 6, wherein
the collecting trough includes a collecting port arranged below the collecting trough, the collecting port connected to the suction port.

10. The liquid treatment apparatus according to claim 6, wherein
the bubble tank includes
a first top plate inclined from the collecting trough toward a center of the bubble tank, and
a second top plate inclined from the opposite side of the collecting trough toward the center of the bubble tank above the first top plate,
the bubble outlet is arranged between the first top plate and the second top plate.

11. The liquid treatment apparatus according to claim 2, further comprising:
a floating matter discharge valve connected to the floating matter discharge port.

12. The liquid treatment apparatus according to claim 2, further comprising:
a lower partition plate arranged in the bubble tank, the lower partition plate having
a lower end connected to a bottom surface of the bubble tank, and
an upper end located below the liquid surface, and
an upper partition plate arranged in the bubble tank, the upper partition plate having
an upper end located above the liquid surface, and
a lower end located above the bottom surface near the bottom surface.

13. The liquid treatment apparatus according to claim 3, further comprising:
a lower partition plate arranged in the bubble tank, the lower partition plate having
a lower end connected to a bottom surface of the bubble tank, and
an upper end located below the liquid surface, and
an upper partition plate arranged in the bubble tank, the upper partition plate having
an upper end located above the liquid surface, and
a lower end located above the bottom surface near the bottom surface.

14. The liquid treatment apparatus according to claim 2, further comprising:
a coalescer arranged in the bubble tank, the coalescer including a plurality of plates each extending in a horizontal direction, the plurality of plates separately arranged in a vertical direction.

15. The liquid treatment apparatus according to claim 3, further comprising:
a coalescer arranged in the bubble tank, the coalescer including a plurality of plates each extending in a horizontal direction, the plurality of plates separately arranged in a vertical direction.

16. The liquid treatment apparatus according to claim 4, further comprising:
a coalescer arranged in the bubble tank, the coalescer including a plurality of plates each extending in a horizontal direction, the plurality of plates separately arranged in a vertical direction.

17. The liquid treatment apparatus according to claim 2, wherein
the bubble tank includes a bubble outlet arranged at upper portion of the bubble tank,
the liquid treatment apparatus further comprising:
a collecting trough arranged below the bubble outlet, the collecting trough configured to collect the floating matter discharged from the bubble outlet; and
a defoaming pump including
a suction port connected to the collecting trough, and
a discharge port connected to the bubble tank.

18. A liquid treatment method, comprising:
mixing microbubbles, at outside of a bubble tank, into a treatment liquid containing foreign matter or oil content, the treatment liquid stored in a tank;
supplying the treatment liquid mixed with the microbubbles into the bubble tank;
floating the microbubbles in the bubble tank by adhering the microbubbles to the foreign matter or the oil content;
flowing the treatment liquid into a separation tank through a lower part of the bubble tank;
circulating the treatment liquid from the separation tank into the tank; and
discharging a floating matter from above a liquid surface of the bubble tank.

19. The liquid treatment method according to claim 18, further comprising:
colliding the foreign matter or the oil content to which the microbubbles are adhered with a platelate to flocculate.

20. The liquid treatment method according to claim 18, further comprising:
filling the bubble tank with the floating matter containing floated microbubbles, the foreign matter or the oil content, and the treatment liquid to overflow from a bubble outlet;
collecting the floating matter to a collecting trough; and
returning the floating matter collected from the collecting trough to the bubble tank with the microbubbles collapsed.
